(19) United States
(12) Patent Application Publication
(10) Pub. No.: US 2005/0003773 A1
(43) Pub. Date: Jan. 6, 2005

(54) Multiple conversion tuner

(76) Inventors: Nicholas Paul Cowley, Wiltshire (GB); Alan Elkins, Wiltshire (GB)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/838,656

(22) Filed: May 5, 2004

(30) Foreign Application Priority Data
Jun. 7, 2003 (GB) 0313107.5

(51) Int. Cl. H04B 1/18; H04B 15/00; H04B 1/26; H04N 5/50

(52) U.S. Cl. 455/150.1; 455/188.1; 455/313

(57) ABSTRACT

A multiple conversion tuner comprises a plurality of cascade-connected frequency changers, each of which comprises a mixer and a local oscillator. The tuner also comprises a local oscillator frequency selecting circuit which controls the frequencies of the local oscillators. The frequencies are controlled so that the final mixer 10 converts a desired signal to the final intermediate frequency and so that the frequency band occupied by the desired signal at the output of each mixer is within the passband of the following intermediate frequency part of the tuner. The local oscillator frequencies are also chosen so that there is no signal of unacceptably large level in the frequency band of the desired signal at the final intermediate frequency resulting from mixing of an undesired signal with harmonics higher than the first harmonic of the local oscillator signals.

### TECHNICAL FIELD

The present invention relates to a multiple conversion tuner. Such a tuner may be used, for example, in receivers for receiving broadcast signals by cable distribution networks or from satellite or terrestrial aerials.

### BACKGROUND

Multiple conversion tuners are well known for use in receiving radio signals. Such tuners comprise a plurality of cascade-connected frequency changers, each of which converts the frequency of an input signal to an intermediate frequency. FIG. 1 of the accompanying drawings illustrates a typical double conversion tuner having an antennae input 1 for receiving a broadband radio frequency input comprising a plurality of channels regularly spaced in frequency, for example in the range 50 to 850 MHz. The input 1 is connected to an automatic gain control (AGC) stage 3, which controls the signal level supplied to a first frequency changer 4 so as to maximise the signal to intermodulation plus noise performance.

The first frequency changer 4 performs up-conversion to a first high intermediate frequency and comprises a mixer 5 and a local oscillator (LO) 6 controlled by a phase locked loop (PLL) synthesiser 7. The synthesiser 7 controls the local oscillator 6 so as to convert any selected channel from the input signal to the nominal first intermediate frequency with the desired channel being centred on the first intermediate frequency, for example 1.22 GHz. The synthesiser 7 may be controlled, for example, by an I²C bus microcontroller (not shown).

The output of the frequency changer 4 is supplied to a high intermediate frequency filter 8, for example of the surface acoustic wave type, having a defined centre frequency and passband characteristic. The filtered signal from the filter typically comprises a small number of individual channels and is supplied to a second frequency changer 9 performing down-conversion and comprising a mixer 10, a local oscillator 11 and a PLL synthesiser 12 controlled by the bus microcontroller. The frequency of the local oscillator 11 is controlled by the synthesiser 12 so as to be fixed and the frequency changer 9 performs frequency down-conversion such that the desired channel is centred on the second intermediate frequency, for example 44 MHz.

The output of the frequency changer 9 is supplied to a second surface acoustic wave filter 13 of bandpass type having a single channel bandwidth and optionally of a shaped passband characteristic as defined by the modulation standard of the received signal. The filter 13 thus selects the desired channel at the second intermediate frequency and attenuates or rejects signals outside its passband sufficiently so as to ensure adequate reception performance. The output signal from the filter 13 is supplied to an amplifier 14, whose output is connected to an intermediate frequency (IF) output 15 of the tuner.

In order to provide sufficient isolation and freedom from interference, the tuner is formed inside a Faraday cage 16 which is sub-divided into separate compartments for providing isolation between different sections of the tuner, as illustrated by the bold lines in FIG. 1. This compartmentalising is required to reduce interference, for example between the oscillators 6, 11 and synthesisers 7, 12 in the frequency changers 4, 9. Also, the filter 8 is contained in its own sub-compartment, which is intended to provide isolation such that only the filtered signal is supplied to the second frequency changer 9.

In practice, such screening arrangements are capable of providing good levels of isolation to provide adequate image rejection. However, it has been found that the limited isolation between the sub-compartments can result in objectional interfering tones being present in the output signal at the output 15.

For convenience of manufacture, apertures are generally provided between the sub-compartments of the Faraday cage 16. At the fundamental operating frequencies within the sub-compartments, good electromagnetic isolation can be achieved. However, as frequency increases and wavelength decreases, electromagnetic emission through the apertures increases so that the effective isolation reduces with increasing frequency.

GB2171570 discloses a dual conversion tuner in which the local oscillator frequencies of the first and second frequency changer local oscillators are shifted to avoid spurs resulting from beating between harmonics of the local oscillator frequencies in the final passband of the tuner.

WO84/04637 discloses a tuner of dual conversion type in which the local oscillator frequency of the second frequency changer is selectable between two values to allow the alternatives of high side and low side mixing. The appropriate frequency is selected to avoid “self-quieting spurious responses”, which are described as being beats between local oscillator harmonics occurring in the final passband of the tuner.

US2002/0142748 discloses a technique for preventing beating between local oscillator harmonics from appearing as a spur in the output signal. A table is calculated for predicting when an interfering spur is likely to be produced. The second local oscillator frequency is then adjusted to move the spur out of the passband of the first intermediate frequency filter.

US2002/0122140 discloses a technique for avoiding spurs in IF passbands caused by beating of local oscillator harmonics. The frequencies of both local oscillators of a dual conversion tuner are adjusted by the same amount so as to maintain the desired signal at the final intermediate frequency.

JP1020733 discloses an arrangement in which the frequency of the second local oscillator is controlled for high side or low side conversion in order to avoid an interference spur mechanism.

It has been found that a previously unidentified interference mechanism can result in unacceptable interference, despite the use of Faraday cage isolation. The cause of this has been identified as higher order mixing products “leaking” around the filter 8 and subsequently being down-converted into the passband of the filter 13 by harmonics of the local oscillator signal in the frequency changer 9. The higher order mixing products are produced in the frequency changer 4 by mixing with harmonics in the output signal of the local oscillator 6. The resulting tones produced at the output 15 can have a sufficiently high level to cause perceptible interference and degradation of the recovered channel signal.

### SUMMARY

According to the invention, there is provided a multiple conversion tuner, comprising N cascade-connected frequency changers, where N is an integer greater than one and each ith frequency changer comprises a mixer and a local oscillator, and a local oscillator frequency selecting circuit for selecting the frequencies of at least two of the local oscillators so that:
(i) a desired signal is converted to the Nth intermediate frequency at the output of the Nth frequency changer;
(ii) the frequency band occupied by the desired signal at the output of each ith frequency changer is within the passband of an ith intermediate frequency part of the tuner; and
(iii) there is no signal, of level greater than a predetermined level, in the frequency band of the desired signal at the Nth intermediate frequency resulting from mixing of an undesired signal in at least jth and kth ones of the mixers with Jth and Kth harmonics of the jth and kth local oscillator signals, where each of J and K is an integer greater than 1.

The predetermined level may be substantially equal to zero. As an alternative, the predetermined level may be substantially equal to a maximum permissible level for avoiding perceptible interfering artefacts.

N may be equal to 2.

The first frequency changer may be an up-converter.

The first frequency changer may be tuneable for selecting the desired signal. The local oscillator of the or at least one frequency changer subsequent to the first frequency changer may have an output frequency which is shiftable by at least one discrete step.

The tuner may comprise a bandpass filter between the first and second frequency changers.

The selecting circuit may comprise a respective look-up table for each of the at least two local oscillators for converting a channel request signal to a local oscillator frequency controlling signal in accordance with a predetermined function.

The selecting circuit may comprise an interference detector and a tuning control arrangement for varying the frequencies of the at least two local oscillators so as to reduce interference detected by the detector. The tuning control arrangement may be arranged to vary the frequencies so as to minimise the interference. The interference detector may comprise a bit error rate estimator.

It is thus possible to provide a tuner in which unacceptable interference from this interference mechanism can be eliminated. This allows existing screening or isolation arrangements to be used while providing acceptable performance and may even permit reduced levels of screening to be used so as to simplify manufacture.

It is thus possible to provide a tuner which can be made without substantial special arrangements for electromagnetically screening the local oscillators from each other. For example, such a tuner may be formed in a single monolithically integrated circuit. The interference mechanism described hereinbefore can be substantially avoided or the effect thereof reduced to such a level as to permit acceptable performance. In particular, it is possible to select the local oscillator frequencies so that the effect of any spur can be substantially avoided by moving potential spurious mixing products out of band.

### BRIEF DESCRIPTION OF THE DRAWINGS

FIG. 1 is a block circuit diagram of a known type of double conversion tuner;

FIG. 2 is a block circuit diagram of a tuner constituting a first embodiment of the invention; and

FIG. 3 is a block circuit diagram of a tuner constituting a second embodiment of the invention.

### DETAILED DESCRIPTION

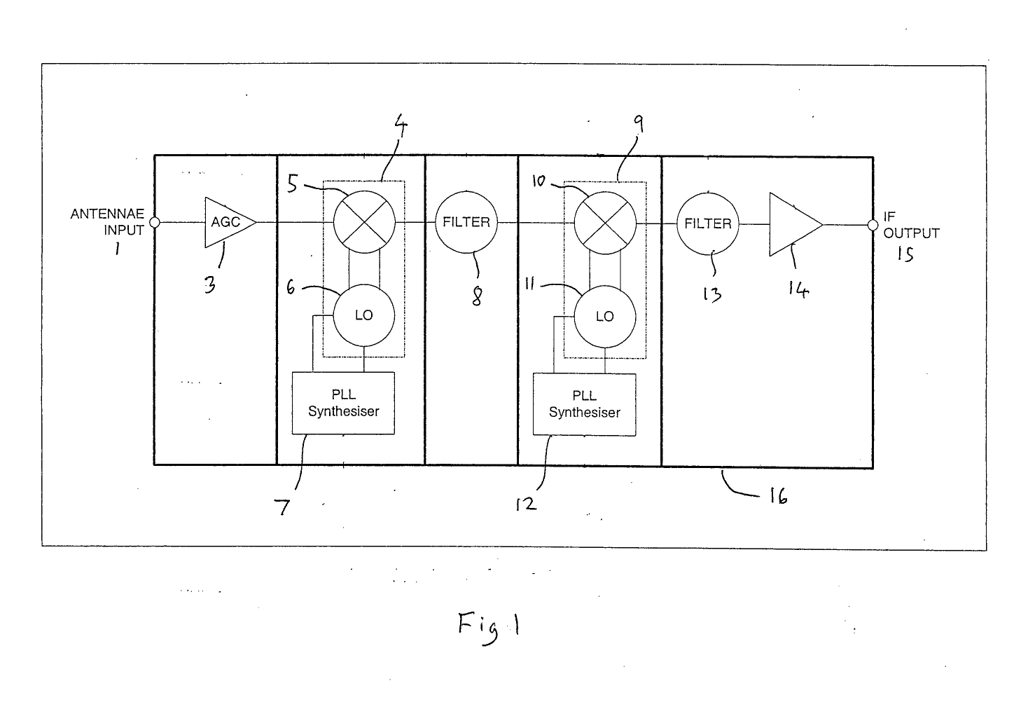

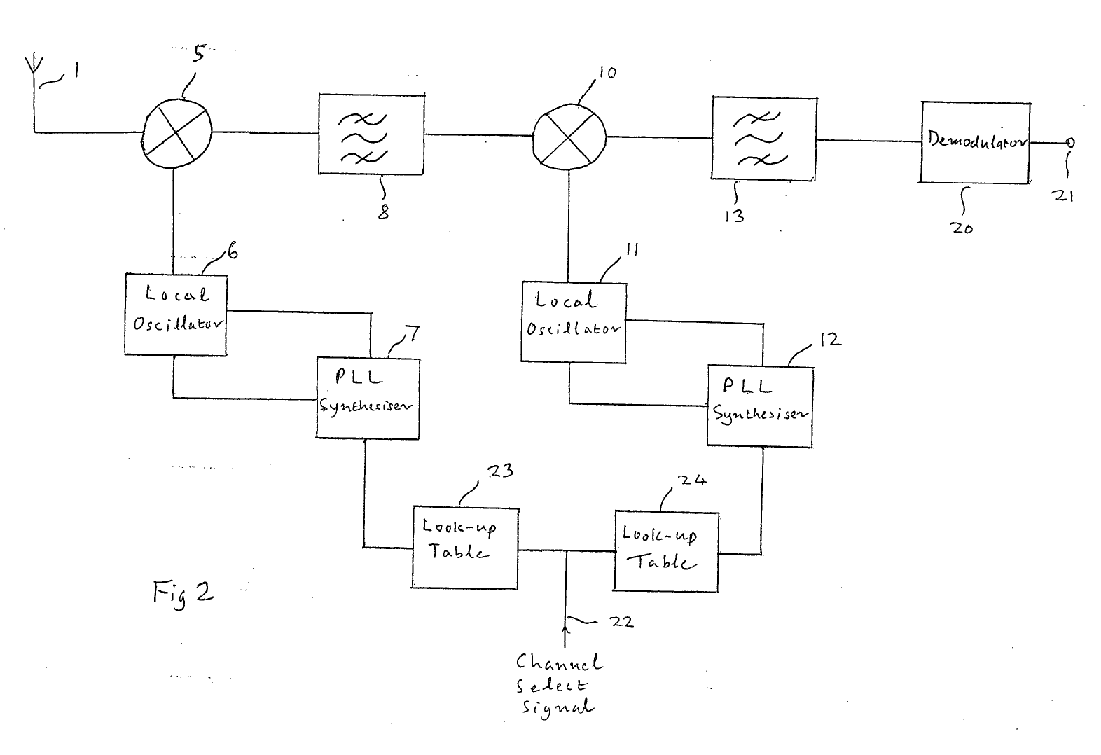

The tuner of FIG. 2 is similar to that of FIG. 1 and comprises an input 1 which may be connected to receive signals from, for example, a cable distribution network or a terrestrial or satellite aerial. The input 1 is connected to a first mixer 5 of a first frequency changer, whose second input is connected to the output of a local oscillator 6 controlled by a phase locked loop (PLL) synthesiser 7. The local oscillator 6 is tuneable so as to select a desired input channel by converting it to the first intermediate frequency. In particular, the first frequency changer comprising the first mixer 5 and the first local oscillator 6 is arranged to perform up-conversion such that the selected channel is converted to an intermediate frequency which is higher than the frequency of the selected channel. In the tuner illustrated, the first intermediate frequency is 1.22 GHz.

The output of the first mixer 5 is supplied to the input of a bandpass filter 8 having a passband centred at the first intermediate frequency. The output of the filter 8 is supplied to the first input of a second mixer 10 of a second frequency changer. The other input of the mixer 10 is connected to a second local oscillator 11 controlled by a second PLL synthesiser 12. The frequency of the local oscillator 11 is selected to convert the desired channel from the filter 8 to a much lower intermediate frequency, for example 45.75 MHz. In known double conversion systems of this type, the second local oscillator has a fixed frequency but, in the tuner shown in FIG. 1, the frequency of the second local oscillator 11 is adjustable, for example in a plurality of discrete small steps, under control of the synthesiser 12.

The second frequency changer performs down-conversion to a relatively low intermediate frequency and the output of the second mixer 10 is supplied to a bandpass filter 13 whose passband is centred on the second intermediate frequency. The output of the filter 13 is supplied to a demodulator 20 for demodulating the signal in the desired channel. Alternatively, the output of the filter 13 may be supplied to a third frequency changer. The demodulated signal is supplied to an output 21.

A channel select signal is supplied to a channel select input 22. The channel select signal is, for example, supplied in response to a user selecting a desired channel for reception and is processed by means (not shown) for supplying suitable codes for controlling the local oscillator frequencies by means of the PLL synthesisers 7 and 12. The channel select signal is of the type which defines the nominal frequency of the local oscillator 6 for selecting the desired channel for reception. However, the channel select signal is supplied to look-up tables 23 and 24 which contain functions for defining the actual frequencies of the local oscillators 6 and 11 in order to receive the desired channel and avoid interference caused by spurious heterodyne products resulting from signal leakages.

An example of the production of such a spurious heterodyne product which could occur in the absence of the remedial measures described hereinafter is as follows. When a channel whose carrier is at 493.25 MHz is to be selected for reception, the local oscillator 6 produces a local oscillator signal at a fundamental frequency of 1713.25 MHz so as to convert the desired channel to the first high intermediate frequency of 1220 MHz. The fundamental frequency of the local oscillator 11 is set to 1174.25 MHz so as to convert the selected channel to the second intermediate frequency of 45.75 MHz. A spurious output from the mixer 5 is produced by the third harmonic of the oscillator 6 performing low-side mixing with a carrier at 487.25 MHz to produce a tone at 4652.5 MHz. Limited isolation causes this tone to be supplied to the mixer 10, where it is mixed with the fourth harmonic at 4697 MHz of the local oscillator 11 to produce an output tone at 44.5 MHz, which is within the output bandwidth (41 to 47 MHz) of the tuner and, in particular, which is within the passband of the second intermediate frequency filter 13.

In order to avoid this problem, the function contained in the look-up table 23 converts the channel select signal supplied to the input 22 so that the synthesiser 7 causes the local oscillator 6 to supply an output signal to the mixer 5 having a frequency 1709.25 MHz which is decreased below the nominal frequency by 4 MHz. The function contained in the look-up table 24 causes the synthesiser 12 to reduce the frequency of the output signal of the local oscillator 11 by 4 MHz to a value of 1170.25 Hz. The desired channel is shifted by 4 MHz at the output of the first mixer 5 but, because the passband of the filter 8 is sufficiently broad, this desired signal is passed to the second mixer 10 with little or no substantial attenuation. Because the frequency of the local oscillator 11 has been shifted in order to compensate for the change from the nominal first intermediate frequency of the desired channel, the desired channel is converted in the second mixer 10 to the second intermediate frequency and is passed by the filter 13.

Because of the shift in frequency of the first local oscillator 5 compared with the conventionally used frequency in a tuner of this type, the third harmonic of the local oscillator signal becomes 5127.75 MHz so that the undesired channel at 487.25 MHz is converted to a frequency of 4640.5 MHz. Similarly, because of the shift in frequency of the second local oscillator 11 compared with the conventionally used frequency, the fourth harmonic is reduced to 4681 MHz so that the undesired channel is converted to a frequency of 40.5 MHz at the output of the mixer 10. This product is outside the bandwidth of the desired channel at the second intermediate frequency and, in particular, is outside the passband of the filter 13 and so is substantially attenuated by the filter 13 to a level such that it does not cause any perceptible interference. Also, the frequency of the undesirable product is separated sufficiently from the frequency of the desired channel at the demodulator 20 so that interference between the signals is substantially reduced or eliminated.

The functions contained in the look-up tables 23 and 24 can be determined during development of the tuner since potential interference can be determined on the basis of the nominal local oscillator frequencies for converting each of the channels to the final intermediate frequency. In a typical example, it is unnecessary to consider local oscillator harmonics above the 10^{th} or 11^{th} harmonic.

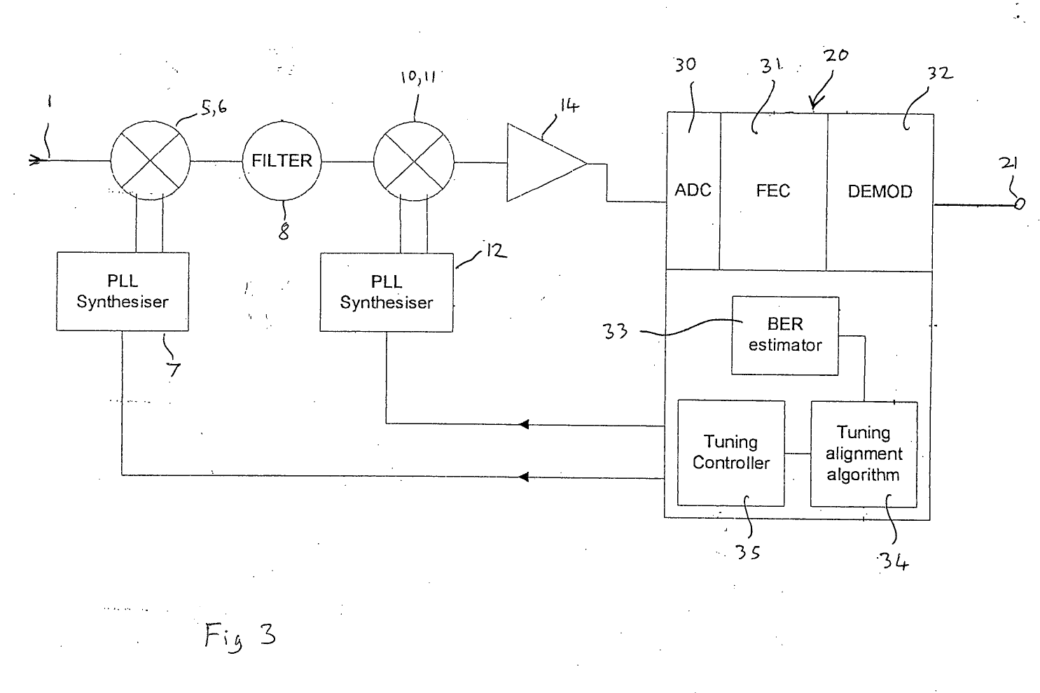

The tuner shown in FIG. 3 differs from that shown in FIG. 2 in that frequency shifting of the local oscillators is controlled dynamically instead of by means of predetermined functions. Thus, the look-up tables 23 and 24 of FIG. 2 are omitted.

The demodulator 20 shown in FIG. 3 comprises an analogue/digital converter (ADC) section 30, a forward error correction (FEC) section 31 and a demodulator (DEMOD) section 32. These sections are of known type and will not be described further.

The demodulator 20 also comprises a bit error rate (BER) estimator 33 which may form part of the FEC section 31. The estimator 33 supplies an output signal which represents the bit error rate or number of errors in the received channel. Such errors may arise from a number of sources, such as phase noise, intermodulation and the spurious heterodyne products as described hereinbefore. The output of the estimator 33 is supplied to a tuning alignment algorithm 34 whose output is supplied to a tuning controller 35, which also receives requests for tuning to a desired channel. The algorithm 34 and the controller 35 may, for example, be implemented as part of software controlling the digital domain demodulator 20.

When the tuning controller 35 receives a request for a desired channel, the PLL synthesisers 7 and 12 are controlled to provide the nominal local oscillator signal frequencies for converting the channel to the first intermediate frequency in the mixer 5 and to the second intermediate frequency in the mixer 10. The bit error rate from the estimator 33 is measured and stored. Alternatively, the number of errors per unit time may be averaged over a predetermined period and stored. Such stored values give a measure of the bit error rate for the nominal tuning of the tuner. The tuning alignment algorithm 34 then controls the synthesisers 7 and 12 so as to offset the local oscillator frequencies in the way described hereinbefore such that the desired channel is converted to the second intermediate frequency at the output of the mixer 10 but is converted by the first mixer 5 to a frequency which is shifted from the nominal first intermediate frequency but such that the converted channel remains within the passband of the filter 8.

The new bit error rate determined by the estimator 33 is then compared with the previous stored value to determine what effect the adjustment in local oscillator frequencies has had on the bit error rate and to determine what further adjustments may be required. For example, if the bit error rate has been reduced, the frequency offsetting and bit error rate comparison may be repeated with further local oscillator frequency offsets in the same direction unless and until a minimum bit error rate is found. If the bit error rate increases, the direction of the frequency offsets of the first and second local oscillators may be changed and the process repeated until a minimum bit error rate is achieved.

The local oscillator frequency offsets may be of a fixed amount. However, it is also possible to perform “alignment” initially at a relatively coarse frequency offset and, when bit error rate has been minimised, to repeat the procedure with smaller frequency offsets until the optimum local oscillator offsets have been determined.

By the use of this technique, spurious heterodyne products can be shifted to frequencies which do not cause any substantial interference with the desired channel within the tuner.

1. A multiple conversion tuner, comprising an input for receiving a plurality of radio frequency input signals of different frequencies, N cascade-connected frequency changers, where N is an integer greater than one and each ith one of said frequency changers, for 1≦i≦N, comprises a mixer and a local oscillator, and a local oscillator frequency selecting circuit for selecting frequencies of at least two of said local oscillators so that:
(i) a desired one of said input signals is converted to an Nth intermediate frequency at an output of an Nth one of said frequency changers;
(ii) a frequency band occupied by said desired signal at an output of each ith one of said frequency changers is within a passband of an ith intermediate frequency part of said tuner; and
(iii) there is no signal, of level greater than a predetermined level, in said frequency band of said desired signal at said Nth intermediate frequency resulting from mixing of any signal corresponding to an undesired one of said input signals in at least jth and kth ones of said mixers with Jth and Kth harmonics of jth and kth local oscillator signals, where each of J and K is an integer greater than one.

2. A tuner as claimed in claim 1, in which said predetermined level is substantially equal to zero.

3. A tuner as claimed in claim 1, in which said predetermined level is substantially equal a maximum permissible level for avoiding perceptible interfering artefacts.

4. A tuner as claimed in claim 1, in which N=2.

5. A tuner as claimed in claim 1, in which a first of said frequency changers is an up-converter.

6. A tuner as claimed in claim 1, in which a first of said frequency changers is tuneable for selecting said desired signal.

7. A tuner as claimed in claim 6, in which said local oscillator of at least one said frequency changer subsequent to said first frequency changer has an output frequency which is shiftable by at least one discrete step.

8. A tuner as claimed in claim 1, comprising a bandpass filter between first and second ones of said frequency changers.

9. A tuner as claimed in claim 1, in which said selecting circuit comprising a respective look-up table for each of at least two of said local oscillators for converting a channel request signal to a local oscillator frequency controlling signal in accordance with a predetermined function.

10. A tuner as claimed in claim 1, in which said selecting circuit comprises an interference detector and a tuning control arrangement for varying said frequencies of at least two of said local oscillators so as to reduce interference detected by said detector.

11. A tuner as claimed in claim 10, in which said tuning control arrangement is arranged to vary said frequencies so as to minimise the interference.

12. A tuner as claimed in claim 10, in which said interference detector comprises a bit error rate estimator.
